(19) United States
(12) Patent Application Publication
(10) Pub. No.: US 2019/0356493 A1
(43) Pub. Date: Nov. 21, 2019

(54) BLOCKCHAIN-ANCHORED SMART DOCUMENTS

(71) Applicant: Integra, Inc., Denver, CO (US)

(72) Inventors: David A. Fisher, Centennial, CO (US); David O. Berger, Las Vegas, NV (US); Jay D. Hull, Gresham, OR (US)

(21) Appl. No.: 16/417,698

(22) Filed: May 21, 2019

Related U.S. Application Data
(60) Provisional application No. 62/674,168, filed on May 21, 2018.

(51) Int. Cl. H04L 9/32; H04L 29/06; H04L 9/06

(52) U.S. Cl. CPC H04L 9/3247; H04L 63/102; H04L 2209/38; H04L 63/101; H04L 9/0643; H04L 9/3239

(57) ABSTRACT

A smart document includes enhanced metadata and document content. The enhanced metadata may store an embedded database for recording and tracking a document history and rules. The smart document may be hashed to generate a unique document identifier. The unique document identifier is stored in a distributed ledge and paired with exposed metadata for enforcing access rules for the smart document.

### CROSS-REFERENCE TO RELATED APPLICATION

This application is related to and claims priority under 35 U.S.C. § 119(e) from U.S. Patent Application No. 62/674,168, filed May 22, 2018 entitled “Blockchain-Anchored Smart Documents,” the entire contents of which is incorporated herein by reference for all purposes.

### TECHNICAL FIELD

The present invention relates to document management over a distributed ledger. In particular, the present invention relates to smart document management, access, validation, and distribution over a distributed ledger system.

### BACKGROUND

In many situations, the authenticity of a document may be evidenced by performing a hashing algorithm, such as SHA-256 for example, over the document to generate a unique one-directional value. For example, where the authenticity of a contract agreement is contested, a hash value of the contested document may be compared to an earlier saved hash value. The two hash values matching strongly supports the position that the respective documents used to generate the hash values are identical and thus the contested document is authentic. Likewise, the two hash values failing to match proves that the respective documents used to generate the hash values are not in fact the same and thus the contested document may be taken to be not an authentic document.

However, historical hash values of the document must be stored somewhere in order to retrieve them at a later point such as to, for example, authenticate an allegedly identical document. Storing the hash value of the document in a purely private store obfuscates, if not prevents, an accounting of the hash value itself. For example, it may be difficult or even impossible to prove that the privately stored hash value has not been tampered with. However, storing the document in a public or shared format may be infeasible for various reasons such as privacy concerns, security concerns, business interest concerns, regulatory considerations, and the like. In addition, updating, managing, and/or collaboratively generating a public or shared document can make tracking and distributing correct versions of the document (e.g., version control) difficult or impossible.

### SUMMARY

In one embodiment, a system includes one or more digital documents each including document content and document metadata, the document metadata including one or more access rules each associated with respective user identifiers, a distributed ledger storing one or more entries each including a document identifier paired to a distributed metadata, the document identifier associated with a respective digital document of the one or more digital documents and the distributed metadata comprising a portion of the one or more access rules, and an identity store storing user identities, wherein the document identifier is generated based on the respective digital document and a portions of the metadata is distributed to a requesting user based on the one or more access rules and verification of the requesting user by the identity store, the verification comprising validating existence of a respective user identity within the identity store.

In one embodiment, the metadata also includes one or more digital signatures.

In one embodiment, the one or more signatures also include a public key and a digital signature of the document data.

In one embodiment, the distributed ledger includes a blockchain network.

In one embodiment, the identity store includes a blockchain network.

In one embodiment, the document metadata also includes an embedded database storing one or more of the one or more access rules, document history, or version information.

In one embodiment, the embedded database utilizes a hash tree.

In one embodiment, a method includes receiving a digital document including document content and document metadata, the document metadata including one or more access rules each associated with respective user identifiers, generating a document identifier based on the received digital document by hashing the digital document, storing the document identifier in a distributed ledger in association with a distributed metadata, the distributed including comprising a portion of the one or more access rules, receiving a request from a user, the request including a user identifier and the document identifier, verifying the user by checking for the user identifier in an identity store, and providing a portion of the metadata to the verified user based on the user identifier and the one or more access rules.

In one embodiment, the metadata also includes one or more digital signatures.

In one embodiment, the one or more signatures also includes a public key paired to a private key.

In one embodiment, the distributed ledger includes a blockchain network.

In one embodiment, the identity store includes a blockchain network.

In one embodiment, the document metadata also includes an embedded database storing one or more of the one or more access rules, document history, or version information.

In one embodiment, the embedded database utilizes a hash tree.

In one embodiment, a method includes computing a cryptographic hash of a content portion of a first digital document, but not a metadata portion of the first digital document, to generate a first document identifier, storing the first document identifier, but not the first digital document, on a distributed ledger implemented on a blockchain network operated by multiple entities, editing the first digital document to generate a second digital document, computing a cryptographic hash of a content portion of the second digital document, but not a metadata portion of the second digital document, to generate a second document identifier, storing the second document identifier, but not the second digital document, on the distributed blockchain ledger with a link to the first digital document, computing a cryptographic hash of a content portion of an unknown digital document, but not a metadata portion of the unknown digital document, to generate an unknown document identifier, querying the distributed blockchain ledger to determine whether the unknown document identifier matches the first document, identifier or the second document identifier, whether that matching document identifier is linked to any other document identifiers, and the date when the matching identifier and any linked identifiers were stored in the blockchain ledger.

In one embodiment, the method also includes maintaining an identity blockchain ledger storing public keys associated with known document authors, signing the first document identifier with a first private key corresponding to a first author to generate a signed first document identifier, and uploading the signed first document identifier to the distributed blockchain ledger, signing the second document identifier with a second private key corresponding to a second author to generate a signed second document identifier, and uploading the signed second document identifier to the distributed blockchain ledger, using a public key stored in the identity blockchain ledger to validate the identity of the author of the first digital document or the second digital document.

In one embodiment, the method also includes maintaining an identity blockchain ledger storing public keys associated with verified users, associating content of one of the first document or the second document with a specified public key, the specified public key associated with an accessing user, validating the accessing user identity by checking the identity blockchain ledger for the specified public key when the accessing user attempts to access one of the first document or the second document, and providing access to the associated content to the accessing user based on the specified public key.

In one embodiment, one of the stored first document identifier or the stored second document identifier is paired with a complementary metadata on the blockchain ledger, the complementary metadata including an access list including the specified public key associated with one or more access rights, and validating the accessing user identity also includes checking the access list for the specified public key.

In one embodiment, providing access to the associated content includes providing a decryption key associated with the specified public key and the associated content.

In one embodiment, one of the first digital document or the second digital document includes an embedded database, the embedded database stored in a respective metadata portion of the one of the first digital document or the second digital document.

### BRIEF DESCRIPTION OF THE DRAWINGS

FIG. 1A is a diagram illustrating an example of a blockchain data structure which may be used in implementing embodiments of the present disclosure;

FIG. 1B is a system diagram illustrating a distributed ledger blockchain network which may be used in implementing embodiments of the present disclosure;

FIG. 1C is a system diagram illustrating a network of nodes which may be used in implementing embodiments of the present disclosure;

FIG. 2 is a diagram illustrating a system for unique identifiers for smart documents on a distributed ledger, according to one embodiment of the present disclosure;

FIG. 3 is a diagram illustrating a smart document system, according to one embodiment of the present disclosure;

FIG. 4 is a diagram illustrating a blockchain data structure for storing paired smart document identifiers and metadata, according to one embodiment of the present disclosure;

FIG. 5 is a flowchart illustrating a method for managing smart documents, according to one embodiment of the present disclosure; and

FIG. 6 is a diagram illustrating an example of a computing system which may be used in implementing embodiments of the present disclosure.

### DETAILED DESCRIPTION

Using embedded database technologies, it is possible to store extensive records of all document interactions, including a list of edits and time stamped instances of a document being opened. Further, metadata can be exposed through a data access application programming interface (“API”) allowing for standard create, read, and update operations.

Document self-sovereignty, where a document can be any digital file (e.g., without limitation, Adobe® Acrobat® (.pdf), Microsoft® Word® (.doc, .docx), photos (.jpg, .jpeg, .png, etc.), spreadsheets (.csv, .xls, .xlsx, etc.), invoices, structured data, unstructured data, etc.) containing data in any form and residing on any medium refers to the ability of an owner of the document to control which data in the document is disclosed, to whom it is disclosed, when it is disclosed, and how, or the means through which, it is disclosed. Document data, as used in this disclosure, can include contents of the document (e.g., a photo, a spreadsheet, an article, etc.) as well as, and in addition to, metadata associated with the document. Metadata may include, without limitation, a complete history in detail of all modifications made to the document from the documents inception, including authorial, ownership, temporal and other descriptive information. To achieve such sovereignty, not only may the metadata (of any degree and size) be stored using secure, immutable means, but the metadata may also be made accessible through, for example and without imputing limitation, a data and/or metadata API.

Further, third party access to private metadata can be mitigated through blockchain and other complementary privacy-enhancing technologies. Access to selected portions, or fields, of data can be controlled through a fine-grained access control mechanism, which may utilize public-private key cryptography or the like. For example, users may be associated with a public key which may reside on a public blockchain and so provide a secure lookup. As a result, man-in-the-middle attacks and the like may be avoided.

A document that has been modified with enhanced metadata, as described above, can become a “smart document” and may be further enabled by a smart contract, where the metadata is secure and/or immutable. Additionally, selective access (e.g., to document data and/or metadata) may be achieved through a fine-grained access control mechanism and so enable self-sovereignty in the respective document. In this context, such self-sovereignty may be achieved through encryption/digital signatures by including the documents anchored on a distributed ledger (e.g., blockchain) and by using smart contracts to mediate the consumption and/or distribution of the metadata.

Fields to which the smart document may be related include, for example and without imputing limitation, real estate transactions and law, contract law, medicine, and any field in which either the owner of data wishes to exercise control over that data's distribution and/or consumption or a set of collaborating parties requires the existence of an immutable audit trail describing the history and contents of a document which has had any number of authors. For example, passports, licenses, registrations and the like can be implemented in smart document form according to this disclosure in order to provide authenticated and granular viewing permissions (e.g., to display only a selected content of a license or passport), access permissions (e.g., to provide smart interactions via API such as retrievals, validations, etc.), and other permissions as will be apparent to a person having ordinary skill in the art with the benefit of this disclosure.

The construction of hash trees (including the most common instantiations and/or variants such as Merkle trees and Patricia trees) is a well-known and standard way of ensuring the temporal integrity of a document. That is, hash trees enable one to determine whether a document asserted to be unchanged from a prior version is, in fact, unchanged or whether it has mutated or been modified in some way. While a hash tree comparison may not disclose the nature of the mutation or modification, it can reveal that mutation has occurred and, in some cases, when it occurred. Likewise, hash tree comparisons may reveal that a mutation has not occurred (e.g., respective document hash values match) when it has not, in fact, occurred.

Historical tracking and records may be included within a document itself via the enhanced metadata by including within the enhanced metadata, for example, a hash tree (e.g., a Merkle tree, Patricia tree, etc.) of a complete entire history (data, authorial, temporal, etc.) of the respective document. Additionally, a respective owner of the document can adjust metadata settings to disclose all, some, or none of the document to third parties. In some examples, third parties may be specified and differentiated access rights can be assigned to them by the document owner via the metadata settings.

By enhancing standard document types (e.g., PDF, DOC, DOCX, JPEG, PNG, etc.) to be able to store large scale (e.g., thousands of records) metadata through a time stamped, embedded, read-append-only database, granular access, detailed and auditable record keeping, efficient and effective validation, and document sovereignty can be provided for smart documents.

The immutability of data can be enforced through a variety of mechanisms. In one example, the data is stored using a Merkle tree or Patricia tree. In other words, a document is made self-sovereign by enhancing it through the inclusion in its metadata of a database that has been “Merkle-ized” or “Patricia-ized,” as the case may be. In other embodiments, other hash tree methods of construction may be used.

Operations upon the metadata in such a document can be restricted by access control lists linked to one or more blockchain-based identities. In one example, the blockchain-based identities may include support for multiparty digital signatures which enable memorialization of a state of the document at the time of signing. For example, once a document is signed, the document may be automatically hashed and uploaded, along with user determined metadata, to a distributed ledger (e.g., blockchain, etc.). The hash value from the hashed document may serve as a document identifier and also as evidence of the document integrity and signing as the hash value is at least partially dependent upon the signature data as well as the document content.

Data access may be controlled by various access mechanisms, including, for example and without imputing limitation, a well-defined application programming interface (“API”) layer, using a representational state transfer (“REST”) framework, simple access object protocol (“SOAP”) over hypertext transport protocol (“HTTP”), or the like, in which read and write/append privileges are controlled by the respective access mechanism and access control list. Further, sophisticated context-sensitive code-based rules which take into account, for example and without imputing limitation, role, date or time, accessor identity, and other data provided by third-party and/or other non-sovereign systems, may be enforced through the access mechanism. As a result, modifications to a self-sovereign document mediated by non-sovereign parties can still be enabled to preserve or reinstitute the sovereignty of the original document while the audit trail of the mediated changes is approved and digitally signed by a respective (e.g., self-sovereign or document owner, etc.) party. In some examples, any such enablement may only go into effect only upon providing a successful signature which may, for example, include or be associated with a respective blockchain-based identity. In some examples, the self-sovereign document may then enter a state during which it is not self-sovereign and, subsequently, based on obtaining certain digital signatures, enter a state during which the document is again self-sovereign.

In one example, a data engine can be configured to support arbitrary data structures which may include metadata such as status (complete/incomplete), a detailed history of edits, and/or a table of foreign keys associated with a blockchain identifier. This allows for more efficient data transfer across organizational or system boundaries. As a result, proof of existence can be established for a respective document content state and respective users (e.g., either human or non-human/automated systems) digital signoffs via logging selective data (e.g., the hashes of the selective data) to an external blockchain. Through this establishment of proof of existence, the document in question also operates as a smart document. If such a document serves a particular purpose, such as, for example, a lease, then the document may operate as a “smart” lease, and so forth.

In other examples, based on the type of document and data, both online and offline data access may be provided according to the enhanced metadata of the smart document. The enhanced metadata may also be synced with an external source, such as a centralized database.

In addition to metadata regarding document and workflow state, a smart document as described may be capable of supporting embedded code (e.g., stored as an enhanced metadata field, etc.), allowing for execution of smart contract functionality off chain. For example, and without imputing limitation, a smart contract may automatically query market reporting and the like upon being opened on a user terminal. As described and/or suggested hereinabove, the embedded code can be signed and treated as immutable data in the same way as other enhanced metadata. Further, API methods to process data and execute internal code methods can be provided for the embedded code.

Historically, contents of documents and metadata, such as data related to the documents (e.g., document creator information, edit history, etc.) are kept separate. The document's data and lightweight metadata is usually maintained within the files themselves. However, metadata may also be kept in a centralized database, such as a document management system or a search index. This decoupling can cause severe document reconciliation issues related to finding and/or determining a most recent document version, especially when crossing system boundaries or operating offline.

Documents, such as legal documents, often pass between various internal and external systems, such as a law firm and corporate legal department. Each system may use different identification schemes for documents or entities referred to in the metadata. A blockchain-based document identity provider, such as described above, can include a standards-based mechanism for requesting unique identifications, such as a global universal identifier (“GUID”), and immutable records which can be queried and are automatically synchronized across every node in a respective network.

Further, standards can be embodied in respective document metadata of self-sovereign documents. A blockchain-based distributed ledger can act as a distributed single source of truth for publishing and accessing a most recent version of a particular document. Additionally, adherence to a user-defined schemata can be enforced in code embedded directly into enhanced metadata of a document and which may further be directly exposed on the blockchain-based distributed ledger (e.g., associated with a respective blockchain-based identifier, or hash, for the document). In some examples, the metadata can be processed through off chain code execution in a coding environment, such as embedded script engines and the like.

In effect, self-sovereign smart documents are provided by decoupling data from a centralized system, using a blockchain-identity system, and/or inclusion of code execution. The document may act as an information gathering vehicle and can provide validated and authorized access to internal data based on document, metadata, and environmental contexts. As a result, some advanced blockchain concepts, such as zero-knowledge proofs, may also be enabled.

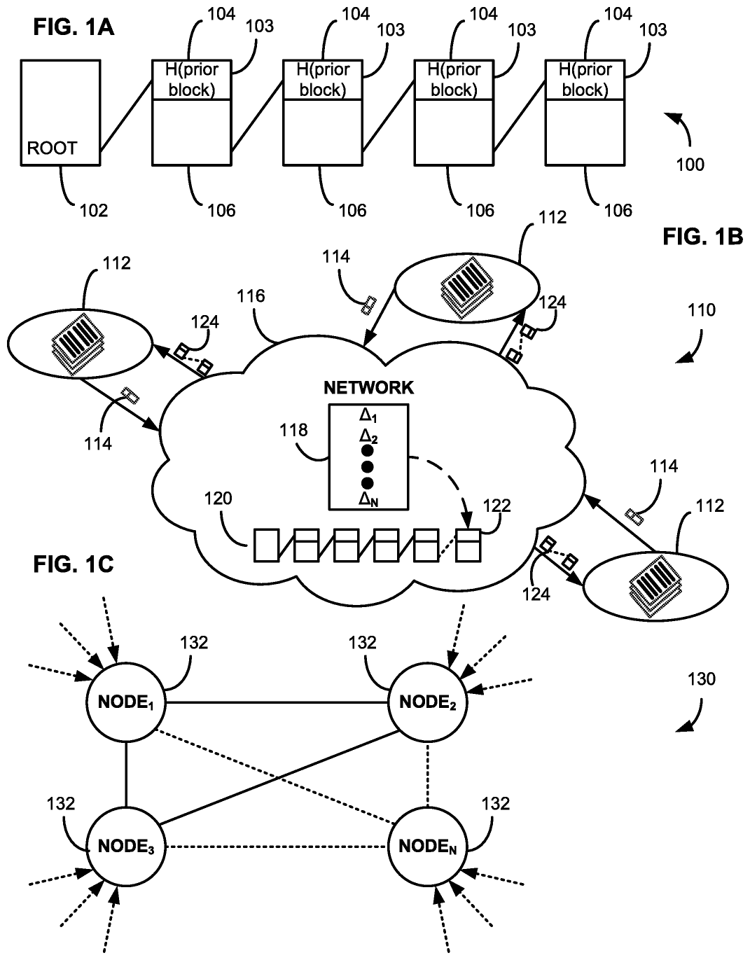

The disclosure now turns to discussion of figures and examples to further understanding of the systems and methods disclosed herein. Beginning in FIGS. 1A-C, examples of a distributed ledger (e.g., blockchain) network conforming to aspects of the present disclosure are shown. In particular, FIG. 1A is a diagram illustrating a blockchain data structure 100 made up of a sequence of linked blocks or nodes. A root block 102 can be generated to form a basis for the blockchain data structure 100 and can contain various descriptive data providing insight into an originating context or content of the blockchain data structure 100 such as timing information, design paradigms for later development along the blockchain, identification or organizational information, and the like. In some examples, the root block 102 may be an entry and/or node on another blockchain or distributed ledger system and, for example, form a sidechain or the like. The root block 102 can also include data or reference to items having relationships to be tracked by the blockchain data structure 100 such as, for example, telephone numbers. Blocks 103 are cryptographically linked directly and indirectly to the root block 102 by a respective header 104 containing a hash of the preceding block 103 in the chain. For example, the block 103 following the root block 102 would include a hash of the root block in the header 104, while the next block in the chain would include a hash of the preceding block, and so on. Where the preceding block 103 is not the root block 102, the hash stored by the header 104 will include the hash stored by the header 104 and the contents 106 of the preceding block.

While cryptography is more widely known for obfuscating data, in the context of a blockchain, a cryptographic hash is used to validate the veracity of the contents of the previous block. Because a hash function will produce a virtually unique value for every given input, it is such that, so long as the hash header properly maps to the purported input (here, the preceding block) from which it was generated, that input is actually the input which originally generated it. In other words, the veracity of the hash is evidence that the preceding block and its contents have not been altered.

The contents 106 of the blocks 103 in the blockchain 100 may contain any type of data that may be represented as a byte stream. However, as depicted by FIG. 1B, a particular implementation may store one or more document packages 114, including a document identifier hash and an enhanced public metadata content, as the contents 106. For example, a network 116 may construct a new block 118 containing N, or an arbitrary number of, document packages 114. The document packages 114 typically represent a unique document version 112, such as an updated document and access schema (e.g., enhanced metadata) that may additionally include identifiers (e.g., document identifier hashes) for earlier document versions. Each unique document version 112 is recorded and transmitted as a document package 114 to the network 116 where, as depicted in FIG. 1C, one or more nodes 132 in a network 130 of nodes receive the record. The N nodes 132 can be fully connected—in other words, every node communicates with every other node—or can connect to an arbitrary and/or random number of other nodes so that all nodes communicate with many other nodes and thus all nodes directly or indirectly communicate with each other. In any case, all nodes 132 in the network 130 of nodes can receive updates to the blockchain 100 from the network. In some embodiments, each node 132 can further validate the veracity of an updated blockchain 120 before affirming receipt or broadcasting the updated blockchain 120 to the remainder of the network 130.

Using the nodes 132, the network 116 will generate a new block 118 containing each of the N document packages 114. For example, the new block 118 can then be appended onto a current blockchain 120 to create a most recent block 122, which includes the document packages 114 in the block contents 106 as well as an appropriate header 104 linking the most recent block 122 to preceding blocks of the blockchain 100. In some embodiments, the new block 118 is generated after a certain threshold number of document packages 114 are received. In other embodiments, after a certain amount of time, such as every 10 minutes, the network generates a new block 118 out of all document packages 114 that have been received since the last block was generated and stored in a pending cache or the like.

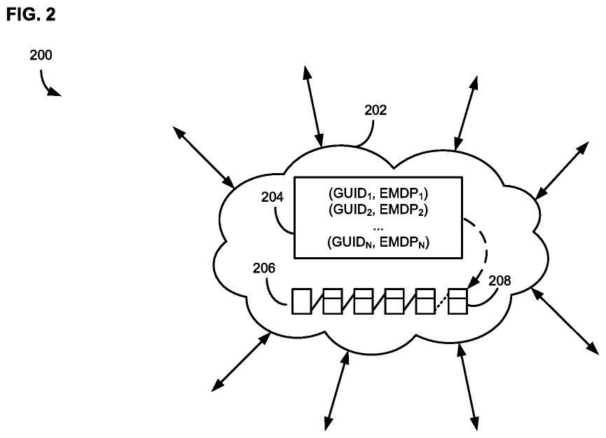

Referring now to FIG. 2, a blockchain ledger system 200 is depicted. In general, the system 200 of FIG. 2 manages blockchain data structure 100 described above in reference to FIG. 1C. Document packages are received over a network 202. In one particular embodiment, the document packages include a GUID, which uniquely identifies a respective and associated document version, paired with an enhanced metadata payload (“EMDP”). In general, the GUID may be generated by executing a hashing algorithm on a document to generate a unique value having, in some examples, statistically infinitesimal likelihood of collision.

An arbitrary number N of document packages can be stored on the new block 204. In some examples, each respective EMDP may before formatted differently from each other. For example, EMDP1 may be of a different schema as defined by an associated user or document owner than EMDP2 or EMDPN, etc. The new block 204 can then receive a hash of the preceding block. For example, and without imputing limitation, a hash algorithm such as SHA-256 can be used to generate a hash of the preceding block, such as, for example and without imputing limitation, “806C1D71841521D166B140D8A43E70F1D4E9A39849304A18627662BBCE79AD3E.”

The new block 204 can then be appended onto a blockchain 206 as a most recent block 208 to produce an updated blockchain and thus preserve an authenticatable record of the document packages stored on the block. For example, a user may perform the hashing algorithm used to generate the GUID on an allegedly identical document. If the document is identical, the generated GUID will match precisely that stored in the new block 204. In addition, the associated EMDP may then be used to perform particular operations or access particular components of the document (e.g., retrieve decryption keys for one or more portions of the document content based on an identifier associated with the user and access control lists and/or executable code stored within the respective EMDP).

In one example, such as in the case of public and private key pairs of an asymmetric encryption, a private key corresponding to the public key may be stored securely on a centralized data store (e.g., a hosting server, server cluster, etc.), local device (e.g., a user device such as a laptop, desktop, tablet, phone, etc.), or the like. The associated decryption key may itself be encrypted with the public key of the associated user. In effect, the user may then use the respective private key (paired to the public key respective to the user) to decrypt the encryption key stored in the EMDP. As a result, man-in-the-middle attacks and the like may be avoided.

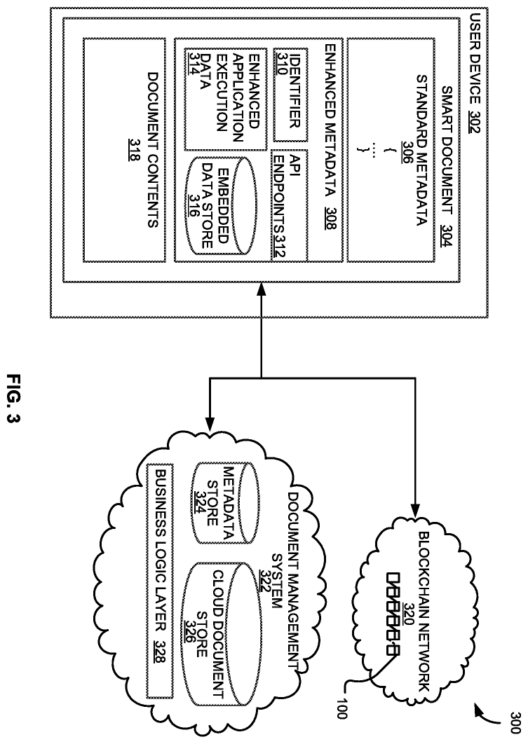

FIG. 3 is a schematic diagram of an example of a smart document 304 and smart document environment 300. In particular, a user device 302 communicates with a blockchain network 320 managing blockchain 100. User device 302 also communicates with a document management system 322, which may be, for example, an enterprise document manage and storage solution or the like. User device 302 may be, for example and without imputing limitation, a desktop computer, laptop computer, smartphone, mobile device, tablet computer, and the like.

In some examples, the document management system 322 may include a metadata store 324 for storing metadata associated with particular documents stored in cloud document store 326. A business logic layer 328 within document management system 322 may enforce document access protocols (e.g., user authentication, etc.), version tracking, and/or automated smart document configuration as a document is accessed and/or retrieved from the document management system 322.

The user device 302 accesses the smart document 304, which may be retrieved from the document management system 322. The smart document 304 includes standard metadata 306, document contents 318, and enhanced metadata 308. Standard metadata 306 can include authorship, time, version, location, and other information associated with the document contents 318 and/or creation of the smart document 304. Document contents 318 may include primary operative document data such as, for example and without imputing limitation, pixel/image information, literal text strings, comma-separated values, and the like.

The enhanced metadata 308 includes an identifier 310, API endpoints 312, enhanced application execution data 314, and an embedded data store 316. The identifier 310 may be the hash value of the smart document 304 and can be generated by performing a hashing algorithm on the smart document 304 and some or all of its components—with the exception of the identifier 310 itself which is the generated output of the hashing algorithm and may then be stored within the smart document and used for retrieving and/or validating the document from blockchain network 320.

API endpoints 312 may include various entry functions for retrieving and/or responding to API calls such as REST or SOAP over HTTP calls and the like. For example, a smart contract embodied by the smart document 304 may include obligations contingent on external events such as timing, stock prices, etc. In effect, API endpoints 312 can provide access points for retrieving external event data to determine triggering of the contingent obligations.

Enhanced application execution data 314 may include executable code and/or code execution elements for performing customized actions by the smart document 304 which may be defined by a user (e.g., during creation of the smart document 304 at document creation, etc.). For example, functional programming concepts known by those of ordinary skill in the art can be used with the benefit of this disclosure to produce enhanced application execution data 314 that may include both rules for code execution (e.g., compilation, interpretation, etc.) and code to be executed by the rules to perform specified tasks.

The embedded data store 316 may store various encrypted data such as, for example and without imputing limitation, a document history, rules, access control lists, field and/or content decryption keys, signatures, and the like.

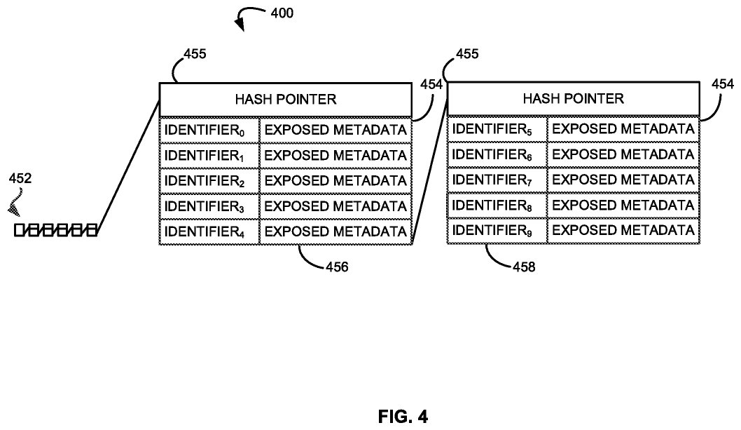

FIG. 4 is an example of a blockchain 400 used to store smart document universal identifiers for verification and/or validation of accessed smart documents. In particular, blockchain 400 includes an earlier portion 452 of interlinked blocks 454. Each block 455 includes a plurality of identifiers 458 paired with respective exposed metadata 456. The identifiers 458 may be hash values generated from a respective smart document as discussed above. The exposed metadata 456 can include user specified schema including access control lists, rules, signatures, and various access levels for decrypting predetermined portions of a respective associated smart document based on user defined rules stored within the exposed metadata 456.

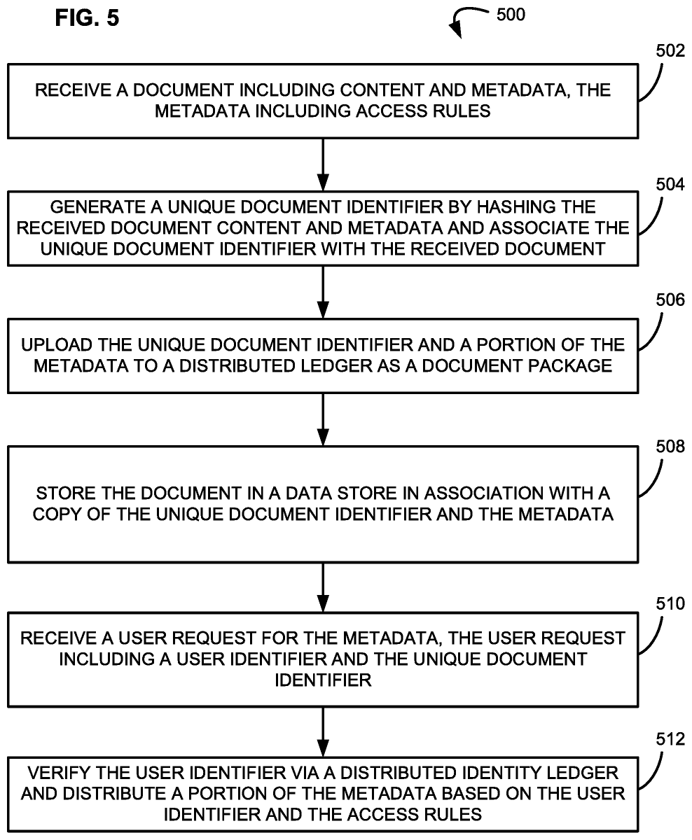

FIG. 5 is a method 500 for managing smart documents partially over a distributed ledger (e.g., blockchain). At step 502, a document is received which includes content and metadata. Further, the metadata may include access rules such as, for example and without imputing limitation, access control lists, decryption rules, and the like. For example, the metadata may include rules allowing for particular users, identified by a respective public key, to decrypt certain portions of the smart document content after certain events have occurred (e.g., a payment event, etc.).

At step 504, a unique document identifier is generated by hashing the received document content and metadata and the identifier is associated with the received document. For example, the identifier may be stored in a metadata field directly in the received document.

At step 506, the unique document identifier and a portion of the metadata is uploaded to a distributed ledger, such as a blockchain network, as a document package. The distributed ledger can be a public or private ledger. In some examples, such as that discussed above in reference to FIG. 4, the unique document identifier and respective portion of metadata may be stored alongside other paired unique document identifiers (e.g., associated with other smart documents) and metadata portions in a single block.

At step 508, the document is stored in a data store in association with a copy of the unique document identifier and the metadata. For example, the unique document identifier and the metadata may be stored directly within the smart document (e.g., embedded). In some examples, either, both, or portions of the unique document identifier and the metadata may be stored in a separate data store from the document and may be associated with the document via reference or the like.

At step 510, a user request is received for the metadata and includes a user identifier and the unique document identifier. In some examples, the user request may be an access request. In some examples, the user request may be a look request seeking only verification of the existence of the unique document identifier on the distributed ledger (e.g., to authenticate a document version, etc.).

At step 512, the user identifier is verified via an identity ledger and a portion of the metadata is distributed based on the verified user identifier and access rules. For example, the access rules may provide for a decryption key for specific portions of the content of a smart document for specific users. As a result, the decryption key, stored in the metadata along with the access rules, can be distributed to the user upon successful verification of the user identifier.

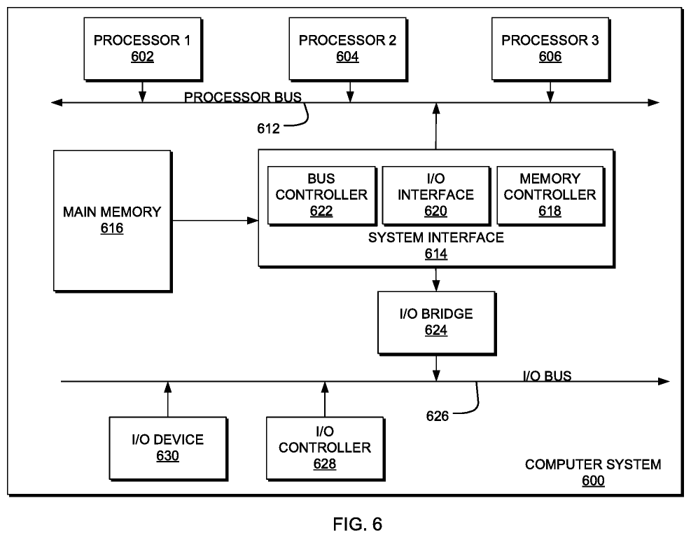

FIG. 6 is a block diagram illustrating an example of a computing device or computer system 600 which may be used in implementing the embodiments of the systems disclosed above. For example, the computing system 600 of FIG. 6 may be node 132 from FIG. 1C and/or user device 302 from FIG. 3 discussed above. The computer system (system) includes one or more processors 602-606. Processors 602-606 may include one or more internal levels of cache (not shown) and a bus controller or bus interface unit to direct interaction with the processor bus 612. Processor bus 612, also known as the host bus or the front side bus, may be used to couple the processors 602-606 with the system interface 614. System interface 614 may be connected to the processor bus 612 to interface other components of the system 600 with the processor bus 612. For example, system interface 614 may include a memory controller 618 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. One or more I/O controllers and/or I/O devices may be connected with the I/O bus 626, such as I/O controller 628 and I/O device 630, as illustrated. The system interface 614 may further include a bus controller 622 to interact with processor bus 612 and/or I/O bus 626.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 616. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages should be understood by the foregoing description, and it should be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for managing smart documents, the system comprising:
one or more digital documents each comprising document content and document metadata, the document metadata including one or more access rules each associated with respective user identifiers;
a distributed ledger storing one or more entries each comprising a document identifier paired to a distributed metadata, the document identifier associated with a respective digital document of the one or more digital documents and the distributed metadata comprising a portion of the one or more access rules; and
an identity store storing user identities;
wherein the document identifier is generated based on the respective digital document and a portions of the metadata is distributed to a requesting user based on the one or more access rules and verification of the requesting user by the identity store, the verification comprising validating existence of a respective user identity within the identity store.

2. The system of claim 1, wherein the metadata further comprises one or more signatures.

3. The system of claim 2, wherein the one or more signatures further comprises a paired public key and private key.

4. The system of claim 1, wherein the distributed ledger comprises a blockchain network.

5. The system of claim 1, wherein the identity store comprises a blockchain network.

6. The system of claim 1, wherein the document metadata further comprises an embedded database storing one or more of the one or more access rules, document history, or version information.

7. The system of claim 6, wherein the embedded database comprises a hash tree.

8. A method for managing a smart document, the method comprising:
receiving a digital document comprising document content and document metadata, the document metadata including one or more access rules each associated with respective user identifiers;
generating a document identifier based on the received digital document by hashing the digital document;
storing the document identifier in a distributed ledger in association with a distributed metadata, the distributed metadata comprising a portion of the one or more access rules;
receiving a request from a user, the request including a user identifier and the document identifier;
verifying the user by checking for the user identifier in an identity store; and
providing a portion of the metadata to the verified user based on the user identifier and the one or more access rules.

9. The method of claim 8, wherein the metadata further comprises one or more signatures.

10. The method of claim 9, wherein the one or more signatures further comprises a paired public key and private key.

11. The method of claim 8, wherein the distributed ledger comprises a blockchain network.

12. The method of claim 8, wherein the identity store comprises a blockchain network.

13. The method of claim 8, wherein the document metadata further comprises an embedded database storing one or more of the one or more access rules, document history, or version information.

14. The method of claim 13, wherein the embedded database comprises a hash tree.

15. A method for validating the contents of a digital document, the method comprising:
computing a cryptographic hash of a content portion of a first digital document, but not a metadata portion of the first digital document, to generate a first document identifier;
storing the first document identifier, but not the first digital document, on a distributed ledger implemented on a blockchain network operated by multiple entities;
editing the first digital document to generate a second digital document;
computing a cryptographic hash of a content portion of the second digital document, but not a metadata portion of the second digital document, to generate a second document identifier;
storing the second document identifier, but not the second digital document, on the distributed blockchain ledger with a link to the first digital document;
computing a cryptographic hash of a content portion of an unknown digital document, but not a metadata portion of the unknown digital document, to generate an unknown document identifier;
querying the distributed blockchain ledger to determine whether the unknown document identifier matches the first document identifier or the second document identifier, whether that matching document identifier is linked to any other document identifiers, and the date when the matching identifier and any linked identifiers were stored in the blockchain ledger.

16. The method of claim 15, further comprising the steps of:
maintaining an identity blockchain ledger storing public keys associated with known document authors;
signing the first document identifier with a first private key corresponding to a first author to generate a signed first document identifier, and uploading the signed first document identifier to the distributed blockchain ledger;
signing the second document identifier with a second private key corresponding to a second author to generate a signed second document identifier, and uploading the signed second document identifier to the distributed blockchain ledger;
using a public key stored in the identity blockchain ledger to validate the identity of the author of the first digital document or the second digital document.

17. The method of claim 15, further comprising:
maintaining an identity blockchain ledger storing public keys associated with verified users;
associating content of one of the first document or the second document with a specified public key, the specified public key associated with an accessing user;
validating the accessing user identity by checking the identity blockchain ledger for the specified public key when the accessing user attempts to access one of the first document or the second document; and
providing access to the associated content to the accessing user based on the specified public key.

18. The method of claim 17, wherein one of the stored first document identifier or the stored second document identifier is paired with a complementary metadata on the blockchain ledger, the complementary metadata including an access list including the specified public key associated with one or more access rights, and wherein validating the accessing user identity further comprises checking for the access list for the specified public key.

19. The method of claim 17, wherein providing access to the associated content includes providing a decryption key associated with the specified public key and the associated content.

20. The method of claim 15, wherein one of the first digital document or the second digital document includes an embedded database, the embedded database stored in a respective metadata portion of the one of the first digital document or the second digital document.
